(19) United States
(12) Patent Application Publication
(10) Pub. No.: US 2013/0240664 A1
(43) Pub. Date: Sep. 19, 2013

(54) METHOD FOR DETERMINING RELATIONAL SPEED AND POSITION IN AN AIRCRAFT EQUIPPED WITH A LANDING GEAR DRIVE WHEEL

(71) Applicant: BOREALIS TECHNICAL LIMITED, London (GB)

(72) Inventors: Isaiah W. Cox, Baltimore, MD (US); Rodney T. Cox, North Plains, OR (US)

(73) Assignee: Borealis Technical Limited, London (GB)

(21) Appl. No.: 13/802,678

(22) Filed: Mar. 13, 2013

Related U.S. Application Data
(60) Provisional application No. 61/611,790, filed on Mar. 16, 2012.

(51) Int. Cl. B64C 25/40; G01B 11/14

(52) U.S. Cl. CPC B64C 25/405; G01B 11/14
USPC 244/50; 356/28

(57) ABSTRACT

A method is provided for determining a relational speed and position of two moving components, preferably an aircraft landing gear drive wheel, a component of the drive wheel, a drive means driving the landing gear drive wheel, or a component of the drive means, using fiber optic technology. Speed and positional information relating to the relative positions of a part of a landing gear drive wheel and a part of a drive means driving the drive wheel can be obtained to ensure their proper engagement or interaction. A single optical fiber preferably provides information relating to drive wheel speed, drive means speed, drive wheel position, and drive means position, therefore enabling efficient autonomous ground travel of an aircraft equipped with this system. The present method can also be employed to monitor aircraft wheel speed in aircraft that use thrust from the engines to move an aircraft on the ground.

### PRIORITY CLAIM

This application claims priority from U.S. Provisional Application No. 61/611,790, filed Mar. 16, 2012, the disclosure of which is fully incorporated herein.

### TECHNICAL FIELD

The present invention relates generally to methods for determining the speed and position of wheels and rotating structures and specifically to a method using fiber optic technology for determining relative speed and position of an aircraft landing gear drive wheel driven by drive means capable of moving the aircraft on the ground.

### BACKGROUND OF THE INVENTION

Moving aircraft effectively on the ground between landing and takeoff minimizes delay and improves airport operating efficiency. Keeping aircraft moving efficiently during taxi operations is critical on the congested runways, taxiways, and ramps very often encountered in today's airports. Air traffic control and ground control personnel try to keep ground traffic moving so aircraft can take off on time and delays are minimized. Runway and ramp congestion caused by increasing numbers of flights, stringent aircraft scheduling requirements, and efforts to squeeze large jets into gates originally designed for much smaller aircraft presents challenges to achieving optimum aircraft ground travel.

Once an aircraft has landed, a pilot currently must use the aircraft engines to power the aircraft from the landing runway to its ultimate parking location at a gate or elsewhere. During taxi, the ground movement of the aircraft must be carefully controlled, and the pilot is required to maintain positive control of the aircraft's direction and speed of movement. In addition, the pilot must be alert and able to check visually the location and movements of everything else along the aircraft's taxi path. An awareness of other aircraft that are taking off, landing, or taxiing and consideration of the right of way of these other aircraft is essential to safe aircraft ground movement in today's congested airports. To be able to maintain the high level of situational awareness required for safe taxiing, a pilot must be able to keep his or her eyes on the aircraft's exterior environment rather than in the cockpit. This is difficult to do when a pilot must focus not only on careful operation of the aircraft engines during taxi, but also on the aircraft ground travel speed as the pilot tries to achieve a required time of arrival at a specified traffic flow point at a busy airport. These challenges are additionally present during taxi-out.

While airport surface traffic management systems for ground traffic control can help to eliminate runway delays, especially runway crossing delays, and enable more efficient use of runways, these system do not optimize efficient ground travel speed of individual aircraft. Pilots using such systems are required to comply with speed- or time-based requirements to efficiently navigate a taxi route so that surface movement of all surface traffic can be coordinated precisely. Most airports have recommended taxi speeds during aircraft ground travel after landing and prior to takeoff. It is difficult, however, to set a firm rule that defines a safe taxi speed. What is safe under some conditions may be hazardous under others. A primary requirement for safe taxiing is maintaining safe positive control of ground travel speed.

Systems for controlling aircraft speed on the ground are similar to those used during flight and vary throttle inputs to the engine to adjust engine operation, thereby regulating the speed of ground travel. The use of an aircraft's main engines to move an aircraft on the ground presents challenges, however, ranging from the dangers associated with jet blast and engine ingestion to the reduction in useful engine life caused by ingestion of foreign object debris and continuous engine operation at low taxi speeds rather than optimal air speeds. In addition, aircraft ground travel using the aircraft engines uses significant amounts of fuel and increases fuel costs.

U.S. Pat. No. 7,469,858 to Edelson, owned in common with the present invention, describes a geared wheel motor design that may be used to move an aircraft during ground travel and taxiing without relying on the aircraft's engines or external tow vehicles. Moving an aircraft on the ground during taxi by means other than the aircraft's main engines or turbines has also been described elsewhere in the art. For example, U.S. Pat. Nos. 7,975,960 and 8,220,740 to Cox et al, owned in common with the present application, describe a nose wheel control apparatus capable of driving a taxiing aircraft without the use of the aircraft main engines or tow vehicles. U.S. Patent Application No. 2009/0294577 to Rogues et al describes a device that enables an aircraft to move autonomously on the ground that employs a very specifically defined spiral drive gear to turn an aircraft wheel. In U.S. Pat. No. 7,445,178, McCoskey et al describes a powered nose aircraft wheel system useful in a method of taxiing an aircraft that can minimize the assistance needed from tugs and the aircraft engines, and U.S. Pat. No. 7,226,018 to Sullivan describes a wheel motor useful in an aircraft landing gear wheel designed to provide motive force to an aircraft wheel when electric power is applied. None of the foregoing published patent applications or patents, however, suggests apparatus or method for effectively moving an aircraft during ground travel that determines the relative speed of a powered drive wheel driving the aircraft on the ground, a drive means powering the wheel, a component of the drive means powering the wheel that interacts with the wheel to drive the aircraft on the ground, or a wheel driven by the aircraft engines to move the aircraft on the ground. None of these published applications or patents, moreover, suggests determining a relational position of a part of an aircraft drive wheel and another component part functionally related to the wheel to control speed.

The use of sensors, including optical fiber sensors, to detect vehicle wheel speed in connection with antilock braking systems and traction control systems is described in U.S. Pat. No. 5,602,946 to Veeser et al. This system, however, requires the use of a crystalline magneto-optical material in addition to optical fibers to indicate the rotational speed of a wheel or wheel bearing, and it is not suggested that the system would work without the magneto-optical material. In U.S. Pat. No. 4,767,164, Yeung discloses a reflective optical wheel speed transducer system that is a component of an aircraft antiskid braking system and generates a wheel speed signal used in skid control. Yeung does not suggest determining relational speed of a moving aircraft drive wheel and a moving drive wheel drive means or drive means component or determining relational positions of a drive wheel and a drive wheel drive means or drive means component. U.S. Pat. No. 7,196,320 to Rickenbach describes a passive fiber optic encoder able to determine speed, position, and direction of movement of a linearly moving object. The determination of relational speed and position of an aircraft landing gear drive wheel or drive means powering the drive wheel is not suggested by Rickenbach.

The prior art does not suggest improving the efficient operation of aircraft ground travel in aircraft equipped with landing gear wheel non-engine drive means or one or more wheels driven by the aircraft engines to move the aircraft on the ground that employs fiber optic technology in a method for determining relational speed and position of a driven landing gear wheel with respect to a drive means driving the wheel, a component of the drive means driving the wheel, or a wheel driven by the aircraft engines to move the aircraft on the ground.

### SUMMARY OF THE INVENTION

It is a primary object of the present invention, therefore, to improve the efficient operation of aircraft ground travel in all aircraft and particularly in aircraft equipped with landing gear wheel non-engine drive means by providing a method for determining relational speed and position of a driven gear wheel with respect to a drive means or a drive means component using fiber optic technology.

It is another object of the present invention to improve the efficient operation of aircraft ground travel in aircraft that use thrust from the aircraft's main engines to move the aircraft on the ground by providing a method for determining relational speed and position of a moving landing gear wheel using fiber optic technology.

It is an additional object of the present invention to provide a method for using fiber optics to determine relational drive means speed and position in an aircraft landing gear drive wheel powered by non-engine drive means to move the aircraft autonomously on the ground.

It is a further object of the present invention to employ fiber optic technology to sense the relative speeds and positions of two moving components on an aircraft whereby ground movement of the aircraft can be controlled.

It is yet another object of the present invention to employ fiber optic technology to provide information relating to the relative speeds and positions of two moving components in an aircraft landing gear drive wheel equipped with non-engine drive means to move the aircraft autonomously on the ground without reliance on the aircraft's engines.

In accordance with the aforesaid objects, a method for determining a relational speed and position of two moving components using fiber optic technology is provided. The two moving components are preferably an aircraft landing gear drive wheel and a non-engine drive means used to drive the landing gear drive wheel, or a drive wheel and a component of the drive means. The method further obtains speed and positional information relating to the relative positions of a part of a landing gear drive wheel and a part of a non-engine drive means driving the drive wheel using fiber optic technology to ensure their proper engagement or interaction. The method of the present invention can also be employed to determine relational speed of a landing gear wheel in an aircraft driven on the ground by thrust from the aircraft's engines. A single fiber optic cable can be used to provide information relating to drive wheel speed, drive means speed, drive wheel position, drive means position, and the speed of any landing gear wheel, therefore enabling efficient ground travel of any aircraft equipped with this system.

### BRIEF DESCRIPTION OF THE DRAWINGS

FIG. 1 illustrates a portion of an aircraft landing gear with a pair of landing gear wheels, each equipped with a non-engine drive means for autonomous ground travel and a fiber optic controller to determine relational speed and position in accordance with the present invention; and

FIGS. 2a-2d illustrate schematically variations in operation of the fiber optic controller to determine relational speed and position according to the present invention.

### DESCRIPTION OF THE INVENTION

Equipping an aircraft with a landing gear wheel driven by onboard non-engine drive means enables the aircraft to move efficiently and autonomously without reliance on the aircraft's engines during ground taxi between landing and take off. The optimum control of aircraft autonomous ground travel and taxi requires real time information about the actual speed of the drive wheel and the onboard drive means, as well as components of the drive means. Information relating to drive wheel speed, to the speed of rotating components of the drive means, and to the relative positions of these structures is needed to ensure that the aircraft can be driven efficiently, safely, and effectively on the ground when ground conditions or operation of the drive wheel onboard non-engine drive means require changes in speed of the aircraft. The present method additionally includes monitoring and obtaining information about the speed of any structures connected to an aircraft wheel or to a drive means so that the structure rotates with the wheel or drive means. This could include, for example, gears, clutch structures, tires, and drive means moving parts, such as rotors.

Obtaining information relating to wheel speed in real time is also necessary in aircraft that are not equipped with onboard non-engine drive means to power a landing gear wheel, but use thrust from one or more of the aircraft's engines to move the aircraft during taxi and ground travel. The method of the present invention ensures that these aircraft can be driven efficiently, effectively, and safely during ground travel when ground conditions or operation of the aircraft engines require changes in ground speed.

Although there are available sensing devices that can provide the requisite information, the use of fiber optic technology presents significant advantages in an aircraft ground travel environment. For example, fiber optic components are able to withstand temperature extremes, shocks, and vibrations to which aircraft landing gear are subjected better than sensors commonly used to monitor and obtain information from aircraft landing gear wheels and associated structures.

The fiber optic technology most useful in the method of the present invention is generally referred to as passive fiber optics. Light is directed through an optical fiber from a light source to a device that may include a shutter or similar structure with a plurality of openings that transmit or block light from reaching a mirror or other reflective surface, where it is reflected back through the shutter and the optical fiber to a detector and is then converted to proportional electrical signals that are interpreted by appropriate software to provide desired information. Filters, additional shutters, lenses, and other structures that affect the transmission of light may also be included. When rotational information, such as the speed of a wheel, is desired, the shutter or similar structure is typically mounted to rotate at a rate that is a function of the angular velocity of the wheel. Additional shutter structures may be used to modulate or otherwise affect light transmission.

One type of fiber optic device that is particularly suitable for use in the method of the present invention is the fiber optic encoder described in U.S. Pat. No. 7,196,320 by Rickenbach, which can be used to detect speed, position, and direction of movement of a rotating shaft or a linearly moving object. The disclosure of this patent is incorporated herein by reference. This fiber optic encoder uses a light source to transmit light into an optical fiber to project a beam of light onto a shutter that is movable relative to the optical fiber in coordination with a movable object. The shutter has a series of openings so that the light is projected only through the openings as the shutter moves. The projected light beam may pass through a filter assembly, where it is separated into a pair of wavelength ranges and then projected onto a mirror or reflective surface, or the light beam may be projected directly onto the mirror. Reflected light travels back along the optical fiber and to a detector capable of determining speed and position of the movable object. While this type of system can effectively provide the desired relational wheel and/or drive means speed and position information in conjunction with the present invention, other fiber optical encoder and transducer systems could also be effectively employed for this purpose and are contemplated to be within the scope of the present invention.

The present method for determining relational speed and position of an aircraft landing gear drive wheel and a non-engine drive means that powers the drive wheel is used to determine speed and/or position of one or more landing gear wheels, each driven by non-engine drive means, and/or structures connected to the wheels or drive means that rotate with the wheel or with a drive means. One or more of the nose landing gear or main landing gear wheels can be equipped with onboard non-engine drive means to autonomously move an aircraft during taxi or ground travel. The onboard non-engine drive means selected for use in the present method should be able to drive an aircraft wheel at a desired speed and torque capable of moving an aircraft on the ground at runway speeds. When an aircraft is not driven autonomously, but is driven on the ground by the aircraft's engines, these considerations are not applicable because the engines perform these functions.

A non-engine drive means preferred for powering one or more aircraft landing gear wheels in the present method is a high phase order electric motor of the kind described in, for example, U.S. Pat. Nos. 6,657,334; 6,838,791; 7,116,019; and 7,469,858, all of which are owned in common with the present invention. A geared motor, such as that shown and described in U.S. Pat. No. 7,469,858, is designed to produce the torque required to move a commercial sized aircraft at an optimum speed for ground movement. The disclosures of the aforementioned patents are incorporated herein by reference.

Other motor designs capable of high torque operation across a desired speed range that can move an aircraft wheel to function as described herein may also be suitable for use in the present invention. A particularly preferred motor is a high phase order induction motor with a top tangential speed of about 15,000 linear feet per minute and a maximum rotor speed of about 7200 rpm. With an effective wheel diameter of about 27 inches and an appropriate gear ratio, an optimum top speed of about 28 miles per hour (mph) can be achieved, although any speed appropriate for aircraft ground travel in a particular runway environment could be achieved. A suitable electric motor could be any one of a number of designs, for example an inside-out motor attached to a wheel hub in which the rotor can be internal to or external to the stator, such as that shown and described in U.S. Patent Application Publication No. 2006/0273686, the disclosure of which is incorporated herein by reference. A toroidally-wound motor, an axial flux motor, a permanent magnet brushless motor, a synchronous motor, an asynchronous motor, a pancake motor, a switched reluctance motor, electric induction motor, or any other electric motor geometry or type known in the art and any other onboard motor location are also contemplated to be suitable for use in the present invention. Pneumatic and hydraulic drive means are further contemplated to be within the scope of the present invention.

When an aircraft is equipped with an electric drive means to power one or more landing gear wheels, current to power the electric drive means preferably originates with the aircraft auxiliary power unit (APU). Other power sources could also be used to supplement or replace the APU as a source of power. These power source can include, for example without limitation, an aircraft engine auxiliary power unit, fuel cells, any kind of solar power units, POWER CHIPS™, batteries, and burn boxes, as well as any other suitable power source effective for this purpose.

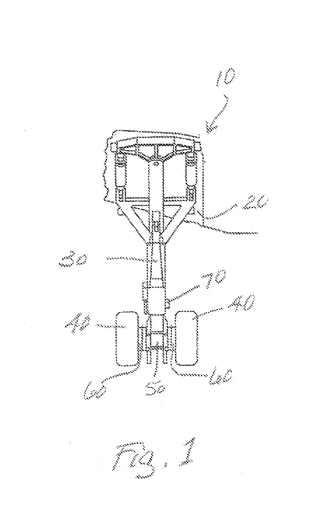

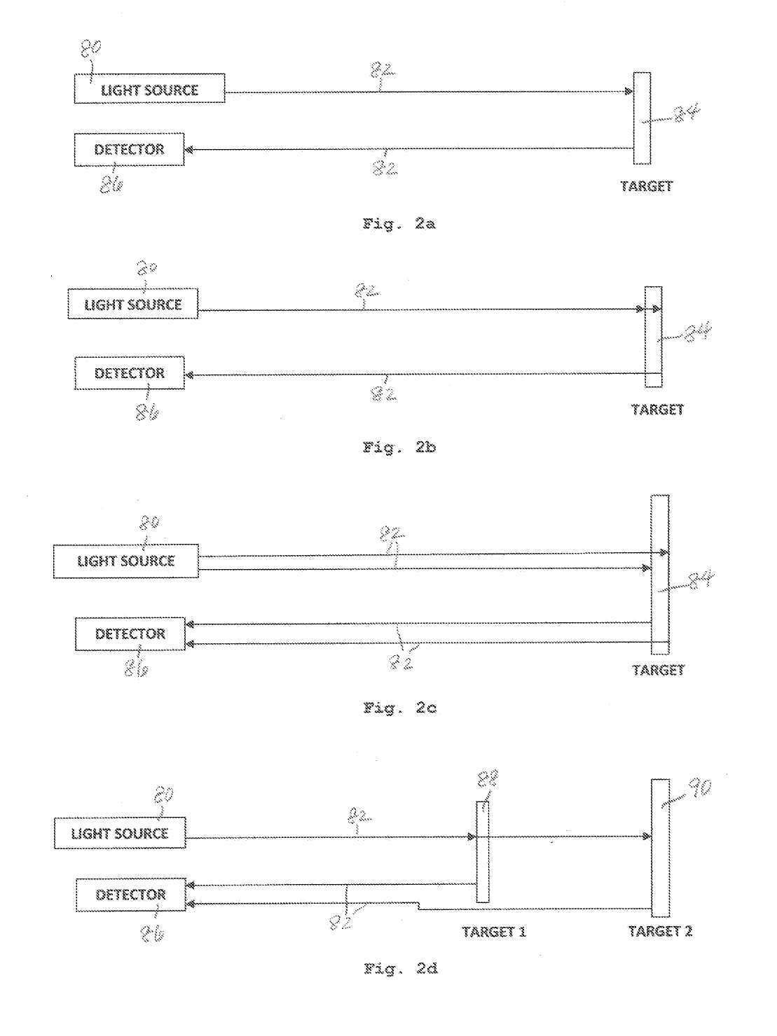

Referring to the drawings, FIG. 1 shows a part of an aircraft landing gear 10. This could be a nose landing gear or a main landing gear. The landing gear 10 extends from a landing gear bay 20 and includes a strut 30. A pair of wheels 40 is rotatably mounted on an axle 50. A pair of drive means 60 is positioned interiorly of the wheels 40 toward the strut 50. Although a pair of drive means 60 is shown, a single drive means could be provided, and this single drive means could be mounted where shown, completely within the wheel 40, or on an outboard side of the wheel 40, farthest away from the strut 30. Similarly, the pair of drive means 60 could be mounted in any of these or another suitable location relative to the wheels 60. A controller 70 is shown mounted on the strut 30. The controller 70 includes a light source (shown in FIGS. 2a-2d) and could be mounted in another location on the strut, within the landing gear bay 20, or in another convenient location. A second controller with a light source (not shown) could also be mounted to direct light through an optical fiber so that each drive means 60 receives light from a dedicated source. Alternatively, a single controller could use a split optical fiber, as described below, to direct light to both landing gear wheels and/or drive means simultaneously. The controller is preferably in a housing that includes, in additional to the light source, a light detector and either the necessary electronics to convert light signals to electrical signals or connectors to such electronics. Optical fibers and/or fiber optic cables connecting the controller 70 to one or more wheels 40 and one or more drive means 60 and/or drive means components are not shown. Optical fibers up to 1000 meters in length can be used effectively in this environment, which provides significant flexibility in determining the most effective location for the controller 70 relative to the wheel, rotating wheel components and/or drive means or drive means components to be monitored.

Monitoring the relational speed and position of the aircraft drive wheel or wheels and wheel components and the speed of the drive means or components of the drive means can be accomplished by using a fiber optic system as described above. FIGS. 2a-2d illustrate schematically various approaches to this process. A light source 80, which could be any one of a number of suitable light sources, such as light emitting diodes (LED), lasers, incandescent light bulbs, or any other light source, is mounted in a location selected to transmit light to a landing gear wheel or drive means part to be monitored. The location of the light source is fixed and will be determined by the configuration of the wheel and/or drive means. When more than one aircraft landing gear wheel is equipped with a non-engine drive means, more than one light source may be required to provide effective monitoring. The light is aimed so that it will be directed along an optic fiber 82 toward a desired selected target 84 on or operatively associated with or linked with a wheel, a rotational component of a wheel, a drive means, or a drive means component, and then reflected back through the same optic fiber to a detector 86 for conversion to proportional electric signals indicative of relational speed and/or position. For clarity, the optic fiber 82 is shown as two structures, but a single optic fiber is used. Light is aimed so that it can be transmitted in one of at least two different orientations. A target 84 will preferably be operatively associated or linked with the structure to be monitored and can be located directly on this structure or remote from the structure. In FIG. 2a, light is directed from the light source 80 to one side of the target 84 along the optic fiber 82 and reflected back along the same optic fiber 82 to a detector 86.

When light is transmitted in a first orientation, the light is aimed to be reflected back from both sides of a target 84, so that the path followed by the light is from the source 80 to one side of the target 84 to the other side of the target 84 to the light detector 86, as shown in FIG. 2b. When light is transmitted in a second orientation, shown in FIG. 2c, the light follows a path from the source 80 to one side of the target 84 and simultaneously to the other side of the target 84, substantially in parallel, and then to the light detector 86. The light could also be aimed so that it is transmitted to and reflected back from more than one selected target as shown in FIG. 2d, for example a drive wheel and a drive means, so that the light follows a path from the source 80 to a drive wheel 88 (Target 1) to a drive means 90 (Target 2) and is reflected back to a light detector 86. Alternatively, the light follows a path from the source 80 simultaneously in parallel to both the drive wheel 88 and the drive means 90 and is then reflected back to the light detector 86, in a manner similar to what is shown in FIG. 2c, when light follows a path to both sides of the target 84. Light received by the light detector 86 is converted to electrical signals indicative of the relational speed or position of the drive wheel and the drive means. A rotational component of the drive wheel or the drive means, such as, for example, a tire or a rotor, could also be a selected target.

When an aircraft is not equipped with onboard non-engine drive means to power one or more landing gear wheels, but uses thrust from the aircraft's engines to move the aircraft on the ground, the speed of one or more landing gear wheels can be monitored substantially as described above using a single controller, such as controller 70 in FIG. 1, with a single light source and a single optical fiber to direct light at one or more selected targets operatively associated or linked with one or more landing gear wheels. The light reflected back from the target or targets associated with one or more wheels is converted to electrical signals indicative of the wheel speed in real time. When light is directed to a target on each of two wheels or to a component that rotates with a wheel, the relational speed of the two wheels or the wheel and the component can be determined. The determination of relational position is not applicable in this situation because there is no drive means directly powering a wheel in the vicinity of the driven wheel or drive wheel components for which positions must be determined.

Within the context of monitoring and determining relational speed and position information in an aircraft landing gear drive wheel equipped with an onboard non-engine drive means, a fixed light source and a fiber optic system can provide, in real time, information required for optimum aircraft ground travel in a range of runway and environmental conditions. For example, the speed of a drive wheel or other aircraft wheel, if desired, in relation to the light source and the speed of a drive means gear and/or clutch in relation to the light source. Both of the foregoing speed values are indicative of the true speed of the wheel, gear, or clutch. It is also possible to determine with high accuracy, depending on the rate at which a shutter or like structure rotates, the relationship between speeds of two structures or components, such as, for example, the wheel and the drive means gear or the wheel and a drive means rotor. Additionally, the relational position of a part of the wheel and a part of the gear can be determined with the present method. Obtaining this relational position information will enable accurate positioning and engagement of the wheel and drive means gearing, as well as to ensure that the speeds of both the wheel and the drive means gear are matched prior to engagement.

The relational speed and position information obtained by a fiber optic system detector or light collector from the light reflected as described above is ascertained by converting the detected or collected light into an electronic form that indicates speed and/or position, or in the case of an aircraft not equipped with onboard non-engine drive means, wheel speed. The relative speeds of each of two components determined as described above can additionally be determined automatically using appropriate computational software. Optical processors, optoelectronic processors, and the like can be used to convert optical signals into electrical signals indicative of speed and/or position. The electrical signals can be sent to a smart processor for processing and then automatic control of a wheel, a drive means, and/or a drive means component as required to produce optimum automatic adjustment of the speed and/or position of one of these components, thereby automatically controlling aircraft ground travel.

When an aircraft is not equipped with onboard drive means, speed can be automatically adjusted and controlled as described. Signals can be sent to the aircraft cockpit controls display to indicate automatic adjustments. If desired, adjustments to wheel, drive means, and/or drive means component speed or position can be performed manually when appropriate signals are sent to the cockpit. In this case, cockpit controls for making the necessary adjustments would be supplied.

The method of the present invention has been described as using a single optical fiber of fiber optic cable to transmit light from a light source and to receive reflected of detected light and then to produce information relating to wheel speed, drive means speed, wheel position, and drive means position. While this is preferred, the use of more than one optical fiber or fiber optic cable may be more appropriate in some wheel and drive means configurations and is contemplated to be within the scope of the present invention. Additionally, the use of a split optical fiber or fiber optic cable that directs light from a single source to two or more separate targets or to two sides of a single target, or that combines light reflected from more than one target, is also contemplated to be within the scope of the present invention.

While the present invention has been described with respect to preferred embodiments, this is not intended to be limiting, and other arrangements and structures that perform the required functions are contemplated to be within the scope of the present invention.

### INDUSTRIAL APPLICABILITY

The present invention will find its primary applicability in monitoring and determining relational speed and position of one or more drive wheels and/or drive means driving the drive wheels of an aircraft equipped with onboard non-engine drive means, and in aircraft not equipped with onboard non-engine drive means that use engine thrust to move the aircraft on the ground, to provide effective control of autonomous aircraft ground travel.

1. A method for determining relational speed and position in an aircraft equipped with one or more landing gear drive wheels driven by onboard non-engine drive means, comprising:
a. providing an aircraft with one or more landing gear drive wheels driven by one or more onboard non-engine drive means to move the aircraft autonomously on the ground;
b. providing control means including a light source and at least one optical fiber to sense and control speed or position of said one or more drive wheels and said one or more drive means; and
c. directing light through said control means optical fiber to one or more selected targets operatively associated or linked with said one or more drive wheels or a component of said drive wheels and said one or more onboard drive means or a component of said drive means while said drive wheel said drive wheel component, said drive means, or said drive means component is in motion to move said aircraft, wherein light reflected from said drive wheel, drive wheel component, drive means, or drive means component through said optical fiber is received and processed by said control means to detect relational speed or position of said drive wheel or drive wheel component and said drive means or drive means component during aircraft ground movement.

2. The method of claim 1, wherein one of said selected targets is operatively associated or linked with a drive wheel and one of said selected targets is operatively associated or linked with a drive means.

3. The method of claim 1, wherein one of said selected targets is operatively associated or linked with a drive means and one of said selected targets is operatively associated or linked with a drive means component.

4. The method of claim 1, wherein one of said selected targets is operatively associated or linked with a drive wheel and one of said selected targets is operatively associated or linked with a drive means component.

5. The method of claim 1, wherein light is aimed and directed to a selected target operatively associated with a drive wheel and a drive means so that the light follows either a first path from the light source to the drive wheel to the drive means and back to the control means or the light follows a second path from the light source to both the drive wheel and the drive means and back to the control means, wherein light received at the control means is processed to determine the relative speeds of the drive wheel and the drive means.

6. The method of claim 1, wherein light is aimed and directed to a selected target operatively associated with a drive wheel and a component of the drive means so that the light follows either a first path from the light source to the drive wheel to the component of the drive means and back to the control means or the light follows a second path from the light source to both the drive wheel and the component of the drive means and back to the control means, wherein light received at the control means is processed to determine the relative positions and speeds of the drive wheel and the component of the drive means.

7. The method of claim 6, wherein the component of the drive means is a gear, and the relative positions and speeds of the drive wheel and the gear are matched.

8. The method of claim 1, wherein said drive means is an electric motor selected from the list comprising toroidally-wound motors, axial flux motors, permanent magnet brushless motors, synchronous motors, asynchronous motors, pancake motors, switched reluctance motors, and high phase order induction motors.

9. The method of claim 1, wherein said drive means is a pneumatic motor or a hydraulic motor.

10. A method for measuring the relative speeds and positions of two movable objects on an aircraft comprising directing a fixed source of light at both said movable objects through a single optical fiber and converting light reflected from both said movable objects to signals representative of the speed and position of one movable object relative to the other movable object, whereby ground movement of said aircraft can be controlled.

11. The method of claim 10, wherein one of said movable objects comprises an aircraft landing gear drive wheel and the other of said movable objects comprises a drive means drivingly mounted to drive said drive wheel to move the aircraft autonomously on the ground.

12. The method of claim 11, wherein one of said movable objects comprises an aircraft landing gear drive wheel and the other of said movable objects comprises a component of a drive means drivingly mounted to drive said drive wheel to move the aircraft autonomously on the ground.

13. The method of claim 10, wherein one of said movable objects comprises a component of said landing gear drive wheel mounted to rotate with said drive wheel and the other of said movable objects comprises a component of said drive means mounted to rotate with said drive means when said drive means is drivingly mounted to drive said drive wheel to move the aircraft autonomously on the ground.

14. A method for determining relational speed in an aircraft using engine thrust to move the aircraft on the ground, comprising:
a. providing an aircraft with one or more landing gear wheels, wherein the aircraft is driven on the ground by thrust from one or more aircraft engines;
b. providing control means including a light source and at least one optical fiber to sense and control speed of one or more landing gear wheels; and
c. directing light through said control means optical fiber to at least one selected target on, operatively associated with, or linked with said one or more landing gear wheels while said landing gear wheel is in motion, wherein light reflected from said landing gear wheel through said optical fiber is received and processed by said control means to detect relational speed of said landing gear wheel.

15. The method of claim 14, wherein light is directed to a selected target operatively associated or linked with each of two landing gear wheels, and the relational speed of each said landing gear wheel is determined.

16. The method of claim 14, wherein said at least one target comprises a landing gear wheel or a component of a landing gear wheel that rotates with a landing gear wheel.
